(19) United States
(12) Patent Application Publication
(10) Pub. No.: US 2008/0319844 A1
(43) Pub. Date: Dec. 25, 2008

(54) Image Advertising System

(75) Inventors: Xian-Sheng Hua, Beijing (CN); Shipeng Li, Redmond, WA (US); Heung-Yeung (Harry) Shum, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/767,410

(22) Filed: Jun. 22, 2007

(51) Int. Cl. G06Q 30/00

(52) U.S. Cl. 705/14

(57) ABSTRACT

Systems and methods are described for image advertising. In one implementation, an image owner registers an image-bearing medium, such as a website, device, email account, messenger account, printing service, etc., including proprietary images, with a service. The service may connect with the image-bearing medium, for example, by using a crawler to find and analyze images and surrounding text on the website or other image-bearing medium. Then a relevancy engine automatically matches each candidate image with one or more relevant advertisements, based on criteria such as visual image content, surrounding text, and textual/thematic description of the image from an automatic content analysis. The matched advertisements are displayed within or near the associated image, whenever the image is displayed or accessed, e.g., on the Internet. The advertisement owner may pay the image owner a monetary compensation, which in one implementation depends on the number of viewers who access the image. The systems and methods may be applied wherever images are displayed, copied, or transferred.

### BACKGROUND

There are vast numbers of proprietary images accessible on the Internet, and countless private collections of images held on local computing devices. There is, however, no conventional system to automatically monetize such images individually, as images per se. Some conventional solutions monetize general web pages, but not specifically the individual images possessed by an owner. Nonetheless, many privately owned images are capable of garnering high attention when a website, device, email, instant message, printing service, etc., containing or displaying such as image is visited and viewed by users within the general public, especially when an image is of high quality, high artistic value, or cleverly composed. But conventionally, there is no automatic way to monetize such privately held images of high attention-getting value.

### SUMMARY

Systems and methods are described for image advertising. In one implementation, an image owner registers an image-bearing medium, such as a website, device, email account, messenger account, printing service, etc., including proprietary images, with a service. The service may connect with the image-bearing medium, for example, by using a crawler to find and analyze images and surrounding text on the website or other image-bearing medium. Then a relevancy engine automatically matches each candidate image with one or more relevant advertisements, based on criteria such as visual image content, surrounding text, and textual/thematic description of the image from an automatic content analysis. The matched advertisements are displayed within or near the associated image, whenever the image is displayed or accessed, e.g., on the Internet. The advertisement owner may pay the image owner a monetary compensation, which in one implementation depends on the number of viewers who access the image. The systems and methods may be applied wherever images are displayed, copied, or transferred, including such diverse contexts as the Internet, websites, networks, photo sharing sites, media handling and exchange modalities, devices, emails, messenger services, printing services, television, electronic and non-electronic billboards, etc.

This summary is provided to introduce the subject matter of image advertising systems, which are further described below in the Detailed Description. This summary is not intended to identify essential features of the claimed subject matter, nor is it intended for use in determining the scope of the claimed subject matter.

### BRIEF DESCRIPTION OF THE DRAWINGS

FIG. 1 is a diagram providing an overview of an exemplary image advertising system.

FIG. 2 is a screenshot of an image that has been associated with a relevant advertisement by the exemplary image advertising system.

FIG. 3 is a screenshot of an image that has been associated with a relevant textual or hyperlink advertisement by the exemplary image advertising system.

FIG. 4 is a block diagram of an exemplary image advertising service.

FIG. 5 is a block diagram of the exemplary registration framework of FIG. 4, in greater detail.

FIG. 6 is a block diagram of the exemplary crawler of FIG. 4, in greater detail.

FIG. 7 is a block diagram of the exemplary content analyzer of FIG. 4, in greater detail.

FIG. 8 is a block diagram of the exemplary advertisement assignment engine of FIG. 4, in greater detail.

FIG. 9 is a block diagram of the exemplary advertisement delivery engine of FIG. 4, in greater detail.

FIG. 10 is a flow diagram of an exemplary method of Internet image advertising.

### DETAILED DESCRIPTION

Overview

This disclosure describes image advertising systems. Exemplary systems allow image owners to submit proprietary images or websites to a service that matches each candidate image with one or more relevant advertisements. The matched advertisements are displayed in or near their associated image, when the image is displayed or accessed, for example, on the Internet or on a mobile device. The advertisement owner may pay the image owner a monetary compensation, which in one implementation depends on the number of viewers who access the image.

The systems and methods may be applied wherever images are displayed, copied, or transferred, including such diverse contexts as the Internet, websites, networks, photo sharing sites, media handling and exchange modalities, devices, emails, messenger services, printing services, television, electronic and non-electronic billboards, etc. Typically an image owner registers a website, folder, device, email account, messenger account, printing service, etc., with an exemplary image advertising service to be described below that matches relevant advertisements with proprietary images. For clarity of description, a website implementation is described below as representative of the many contexts to which the exemplary systems and methods can be applied.

Exemplary System

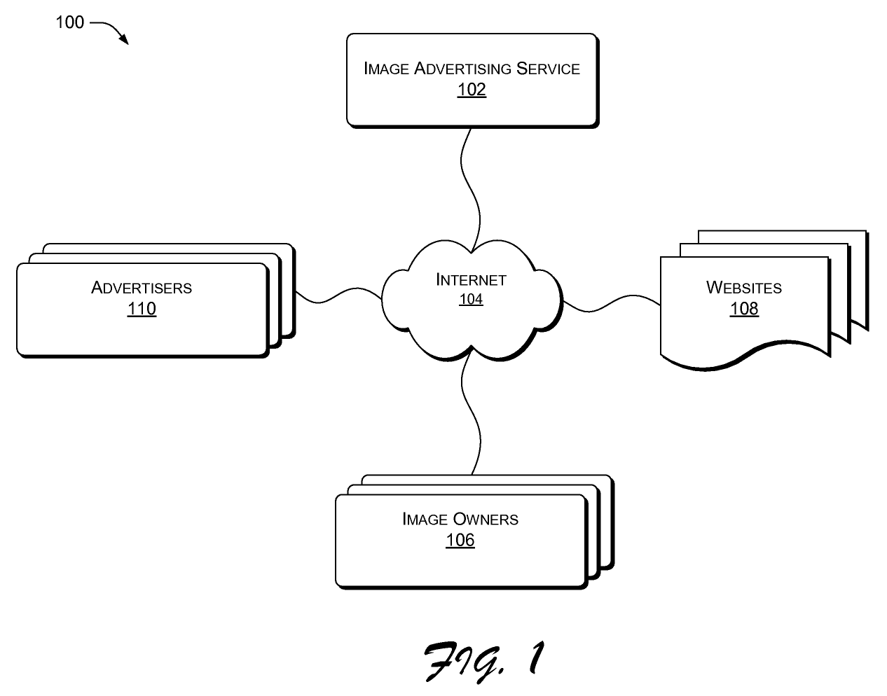

FIG. 1 shows an exemplary image advertising system 100. In this example scenario, an image advertising service 102 is communicatively coupled with a network, such as a mobile phone network, or as illustrated, the Internet 104. In this instance, image owners 106 who also have access to the Internet 104 possess proprietary images, e.g., typically accessible on websites 108. The image advertising service 102 has access to advertisements submitted by participating advertisers 110. When an image owner 106 avails of the image advertising service 102, then the image owner 106 can submit images-for example, privately captured digital photos-to be matched with one or more of the advertisements. Then, each time the image is displayed or accessed on a website 108, the advertisement appears in or with the image.

The various illustrated components of the example image advertising system 100 are communicatively coupled with the Internet 104 via hardware and software of computing devices and distributed computing networks. For example, the components of “image owners” 106 and “websites” 108 include the computing devices by which these components interact with the Internet 104. A computing device may be a desktop or notebook computer, or other device with processor, memory, data storage, etc.

Instead of the Internet 104, the exemplary image advertising service 102 may use other local networks, intranets, wireless channels, etc., as a connecting medium. The image advertising service 102 may be applied through email, messenger, mobile devices, and even conventional services. In a free or low-subscription-rate short message service (SMS) and/or multimedia message service (MMS) for mobile phones, the image advertising service 102 can assist by inserting advertisements into original multimedia short message service images. In another example, the image advertising service 102 can offer free or low-cost photo printing (i.e., to paper) when the image owner 106 allows an advertisement to be printed with the photos (e.g., an unobtrusive advertisement in a corner of the printed photo—placed much like a professional photographer's signature or like a camera's automatic date and time stamp).

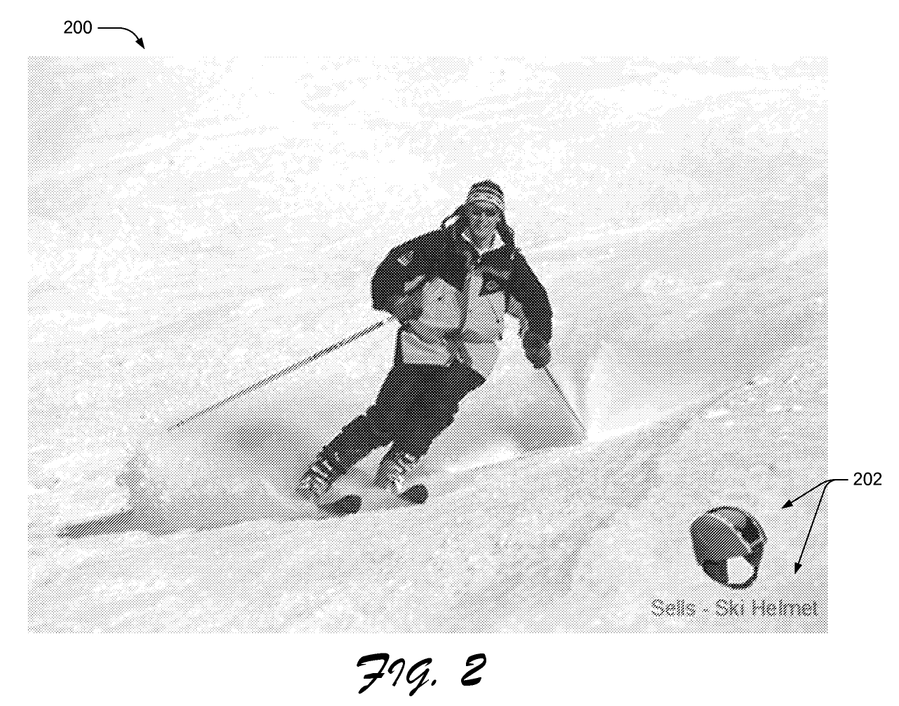

FIG. 2 shows an exemplary image 200 being displayed on a website 108. There are vast numbers of images accessible worldwide, often accessible on the Internet 104. However, there is conventionally no system to monetize the images as resources, per se. Some conventional solutions monetized general web pages, but not individual images specifically. Nonetheless, images typically get high attention when websites are seen or visited by general users, especially high quality images. Advertising through such images is highly effective.

In FIG. 2, the image owner 106 has submitted the image 200 to the image advertising service 102 to be associated with an advertisement 202. In the lower right hand corner of the image 200, the advertisement 202 appears in a relatively non-salient part of the image 200. The advertisement 202 may also appear next to the image 200 instead of within the image 200. Alternatively, the advertisement 202 may appear for a limited time interval, then fade or disappear from view. In one implementation, an advertisement overlays a large portion of the image (even the entire image) for a short interval, and then shrinks to a non-salient area of the image, where the advertisement may be displayed for a longer interval.

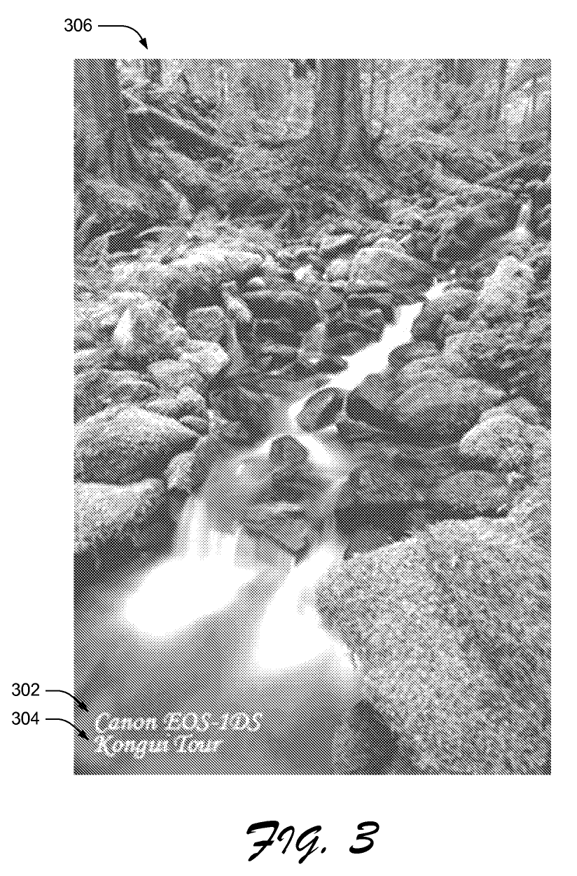

FIG. 3 shows relevant textual advertisements 302 and 304 embedded in a scenery image 306. The first advertisement 302 relates to a camera, the second advertisement 304 relates to a tour—both advertisements 302 and 304 are thematically relevant to a well-photographed image 306 of scenic beauty worth touring. The two advertisements 302 and 304 are not necessarily related to each other, except that both have been associated with the same image 306. The advertisement 302 may consist of text 302 or may be an advertising image 202, animation, video, etc., within the original image 200 as shown in FIG. 2, or may be a combination of advertising text 302 and advertising image 202. The advertisement 302 may also constitute a hyperlink, clickable icon, mouseover point, etc. Activating such a link sends the website user to further information or to a different website hosted by the associated advertiser 110.

An exemplary image advertising system 100 enables multiple functionalities, including support for content-based relevancy matching of advertisements with images; support for long-tail business model for both the image owners 106 and the advertisers 110—in which a statistical distribution of the public exposure of an advertisement 202 and/or image 200 relies on a population of website viewers which gradually tapers off, but in tapering off makes up the bulk of the public exposure. The image advertising service 100 can support automatic advertisement delivery by inserting an agent such as a segment of code in a website 108; and supports targeted advertising.

In contrast to conventional online or networked advertising schemes, the exemplary image advertising system 100 can monetize exposure of images based on relevancy matching. The images 200 and advertisements 202 can be matched according to the content or context of the image 200. The matched advertisements 202 can then be placed into appropriate areas within or nearby the images 200. The exemplary image advertising system 100 provides a solution for monetizing image searches and image sharing, for example, on the Internet 104.

Exemplary Service

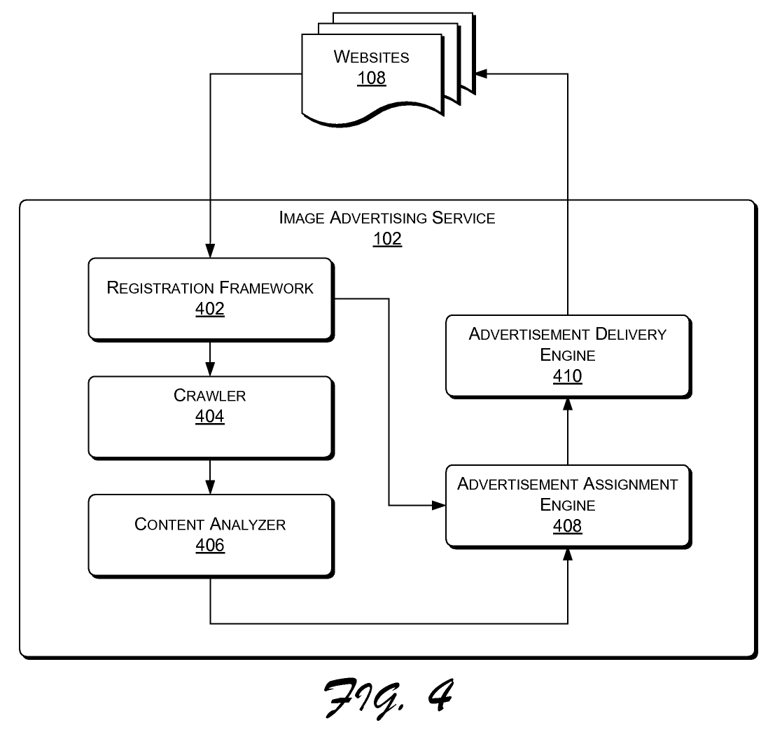

FIG. 4 shows the exemplary image advertising service 102 of FIG. 1, in greater detail. The illustrated implementation is only one example configuration, for descriptive purposes. Many other arrangements of the components of an exemplary image advertising service 102 are possible within the scope of the subject matter. Such an exemplary image advertising service 102 can be executed in hardware, software, or combinations of hardware, software, firmware, etc.

The illustrated image advertising service 102 is communicatively coupled with websites 108, as also shown in FIG. 1, and may include a registration framework 402, a website crawler 404, a content analyzer 406, an advertisement assignment engine 408, and an advertisement delivery engine 410.

To provide an overview of the exemplary image advertising service 102, an example scenario is now described. An image owner 106 has a website 108 containing a number of photo images 200 owned and/or captured by the image owner 106. The website 108 has attracted much web traffic, but the image owner 106 cannot earn a monetary profit by conventionally sharing the photos.

In one implementation of the image advertising service 102, the image owner 106 logs-on to a website of the image advertising service 102 and via the registration framework 402 submits the image owner's website 108 so that advertisements 202 can be associated with the owner's images 200 on the image owner's website 108.

In one implementation, the image advertising service 102 sends an agent, such as a segment of code, for the image owner 106 to add to the source code of the website 108. Then, in one implementation, a website crawler 404 or other engine of the exemplary image advertising service 102 crawls and/or data mines the images 200 and related information on the website 108. A content analyzer 406 of the image advertising service 102 automatically analyzes the content, theme(s), and other features of the images 200. For example, the content analyzer 406 can detect whether there are people/faces in the image 200, whether the image 200 includes sky, mountains, water, etc.; and can determine whether the image 200 has an outdoor theme, a clothing/apparel theme, a sport theme, a shopping theme, a potential product theme, etc. The content analyzer 406 may also determine salient regions and non-salient regions in images 200, for purposes of embedding or overlaying an advertising graphic or text in a non-salient part of the image 200. In one implementation, an advertisement can overlay a larger portion of the image (even the entire image) for a short interval, and then shrink to a non-salient area of the image, where the advertisement may be displayed for a longer interval.

The advertisement assignment engine 408 selects appropriate (i.e., related, relevant) advertising material from its database of advertisements 202 submitted by the participating advertisers 110. This can be accomplished by combining content-based assessments, analysis of related textual information surrounding the image 200, and other analysis results.

If the image owner 106 has added the agent or code segment to his website 108, then the agent automatically retrieves the advertisement information from the advertisement delivery engine 410 and embeds the corresponding advertisements into the associated image 200 (e.g., in one or more regions of the image 200 or positioned near the image 200). Then, when a website visitor views the image owner's website 108, the assigned advertisement 202 is displayed when the image 200 is displayed. The advertisement(s) 202 thus placed can be, or can include, related hyperlinks so that website visitors can link to more details. When the advertisement 202 overlaps the image 200, the advertisement 202 can either be merged into the image(s) 200 or overlaid on the image 200. Either way, one aim of the exemplary system 100 is to display the advertisements 202 in a non-intrusive manner—they are displayed in non-salient areas, are only displayed for a short interval and then disappear, or cover a large area of the image 200 and then shrink into an unobtrusive non-salient region of the image 200.

Alternatively, in one implementation the image owner 106 uploads the images 200 to be associated with advertisements 202 to the image advertising service 102 instead of registering a website 108. A second example scenario describes this process. For example, the image owner 106 may have many digital images 200 available on her computing device. The image owner 106 would like to share a number of these images 200 with friends, so the image owner 106 places the selected images 200 into a sharing folder (such as a sharing folder in WINDOWS LIVE MESSENGER). At the same time, she registers the sharing folder to the registration framework 402 of the image advertising service 102. The image advertising service 102 applies the content analyzer 406 and the advertisement assignment engine 408 to each image 200 in the folder. When the friends or anonymous visitors (if access rights are granted) view the images 200, the associated advertisements 202 and links are embedded in the images 200.

In yet another scenario, third party service providers who host the images 200 submit the images 200 to the registration framework 402 of the image advertising service 102. Such third party service providers may include image sharing websites, blog sites, online forums, etc. In such a case, the service providers may share the advertising revenues with the individual image owners 106 who upload the images 200 into the third party service provider websites.

Likewise, the advertisers 110 can also upload their advertisements (text, image, animation, video clips, etc.) into the image advertising service 102. The image advertising service 102 then does relevancy matching of advertisement(s) to image(s). The image advertising service 102 can support separate business models of both image owners 106 and advertisers 110.

Exemplary Registration Framework

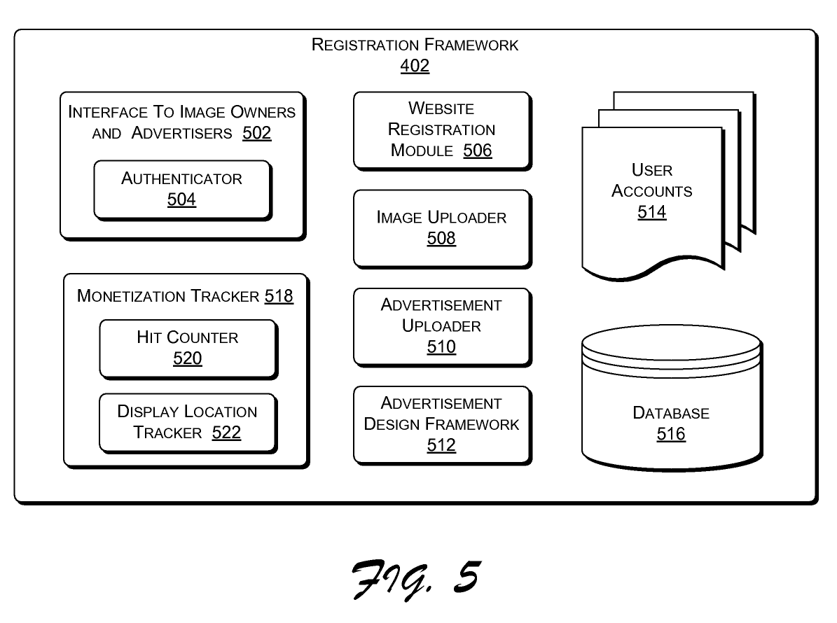

FIG. 5 shows the exemplary registration framework 402 of FIG. 4 in greater detail. The illustrated implementation is only one example configuration, for descriptive purposes. Many other arrangements of the components of an exemplary registration framework 402 are possible within the scope of the subject matter. The exemplary registration framework 402 can be executed in hardware, software, or combinations of hardware, software, firmware, etc.

The illustrated registration framework 402 includes an interface for image owner and advertisers 502, including an authenticator 504 (e.g., to check user names and passwords), a registration module 506, an image uploader 508, an advertisement uploader 510, an advertisement design framework 512, user accounts 514, a database 516 for storing user account information, uploaded images, uploaded advertisements, etc., and a monetization tracker 518, including a hit counter 520 and a display location tracker 522.

The registration framework 402 provides an interface 502, authenticator 504, and user accounts 514 for image owners 106 and advertisers 110 who wish to disseminate advertisements 202 via images 200, for example, over the Internet 104. Users manage their user accounts 514 through the registration framework 402. The advertisers 110 may be advertising agents, product makers, or even individuals who wish to gain exposure for a new product or service via popular images belonging to someone else. The registration module 506 allows image owners 106 to register their web sites/pages 108 that contain image content, and the image uploader 508 allows the image owners 106 to directly upload the images themselves.

Advertisers 110 can upload advertisements 202 via the advertisement uploader 510. Or, the advertisement design framework 512 can provide an advertiser 110 with tools to design an advertisement online within the image advertising service 102 and then register the new advertisement at the registration module 506.

The registration framework 402 provides a database 516 to store the information input by the image owners 106 and advertisers 110 and the associations developed between the images 200 and the advertisements 202.

The monetization tracker 518 includes a hit counter 520 to record how many times particular advertisements 202 are displayed and/or clicked by a website visitor and a display location tracker 522 to record where the advertisements 202 are displayed. Payment to image owners 106 can then be based on performance of the image 200 in successfully disseminating the advertisement 202.

Exemplary Crawler

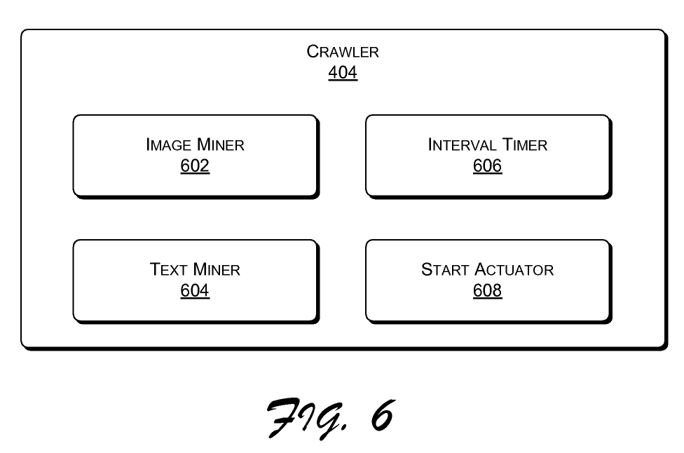

FIG. 6 shows an exemplary website crawler 404 that may be used when an image owner 106 registers a website 108 with the image advertising service 102. The exemplary illustrated crawler 404 has an image miner 602, a text miner 604, an interval timer 606, and a manual start actuator 608. The illustrated implementation is only one example configuration, for descriptive purposes. Many other arrangements of the components of an exemplary crawler 404 are possible within the scope of the subject matter.

In one implementation, the crawler 404 crawls the registered web sites/pages 108 and has both an image miner 602 and a text miner 604 to discover both images 200 and surrounding text, if present. As image owners 106 may change the content of the related website 108, the interval timer 606 may activate the crawler 404 periodically. The start actuator 608 allows the image owner 106 or associated administrator to force the crawler 404 to crawl the content when the content of the website changes, or when manually requested by the image owner 106.

Exemplary Content Analyzer

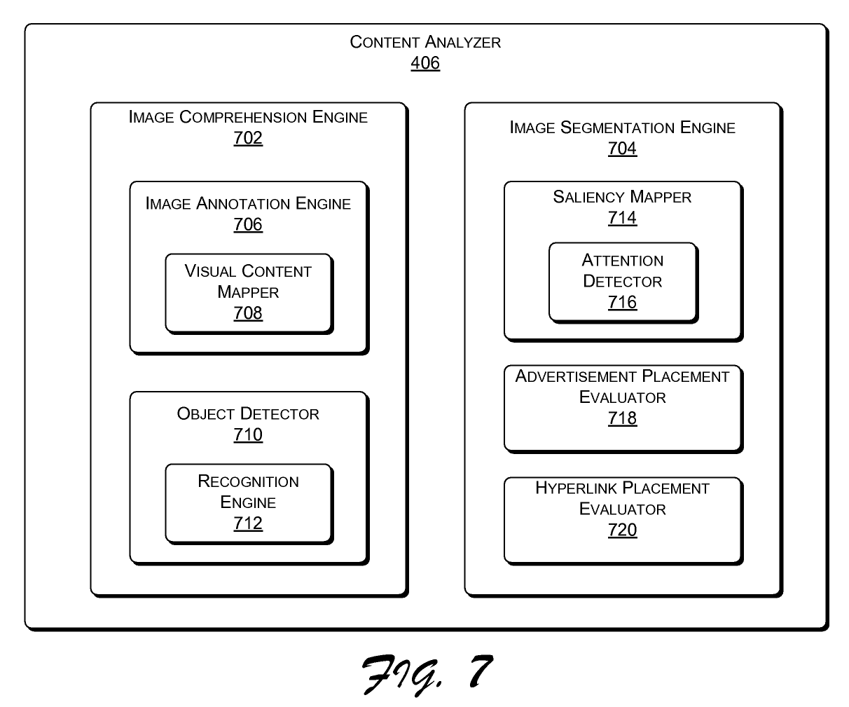

FIG. 7 shows the exemplary content analyzer 406 of FIG. 4, in greater detail. The illustrated content analyzer 406 includes an image comprehension engine 702, and an image segmentation engine 704. The image comprehension engine 702, in turn, may include an image annotation engine 706, a visual content mapper 708, a (visual) object detector 710, and a recognition engine 712. The image segmentation engine 704 may further include a saliency mapper 714 including an (image viewer's) attention detector 716, an advertisement placement evaluator 718, and a hyperlink placement evaluator 720. The illustrated implementation is only one example configuration, for descriptive purposes. Many other arrangements of the components of an exemplary content analyzer 406 are possible within the scope of the subject matter.

The content analyzer 406 analyzes and interprets the content of the registered images 200. The output of the content analyzer 406 is applied at the advertisement assignment engine 408.

In one implementation, the main tasks of the image comprehension engine 702 are to map visual content of the image 200 to textual/thematic description (e.g., “mountain,” “beach,” “scenery,” “crowd,” etc); and to detect specific objects in the image 200 (such as face, car, screen, etc). The image annotation engine 706 includes the visual content mapper 708 to perform the task of image annotation. The object detector 710 includes a recognition engine 712 to perform the task of object recognition. The output of both the image annotation engine 706 and the object detector 710 can be applied in matching advertisements 202 to images 200. The output of the object detector 710 can also be used by the hyperlink placement evaluator 720 to embed advertisement hyperlinks in association with the detected object. For example, when a user does a mouseover of a car in an image, a hint or teaser about a car advertisement can be instantly displayed.

The image segmentation engine 704 finds appropriate image regions to embed advertisements 202 in a particular image 200. Except for advertisements 202 related to a specific object in the image, the advertisement placement evaluator 718 places advertisements 202 in image regions with less visual content in order to avoid annoyance for the viewers. For example, in FIGS. 1 and 2 advertisements are displayed in image regions without significant foreground or background objects. The attention detector 716 assists the saliency mapper 714 to map visually significant image regions, and then the inverse of such a saliency map can be regarded as an advertisement-embedding suitability map. For most cases, the advertisements 202 are embedded in a region close to the corners or borders of the image 200. In addition, the color of the selected region can also be taken into account when the advertisement delivery engine 410 renders the advertisements so that the advertisement 202 can be clearly distinguished and not blend into similar colors.

Exemplary Advertisement Assignment Engine

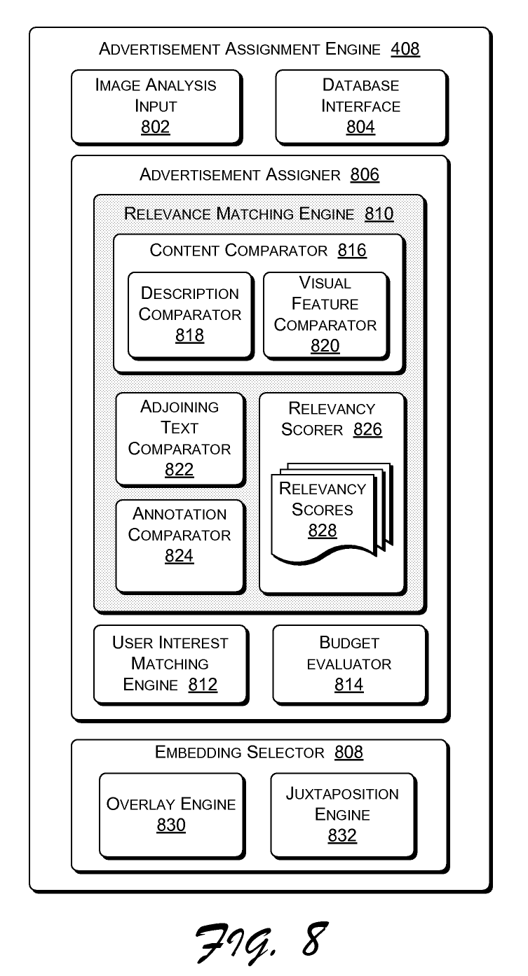

FIG. 8 shows the advertisement assignment engine 408 of FIG. 4, in greater detail. The illustrated implementation is only one example configuration, for descriptive purposes. Many other arrangements of the components of an exemplary advertisement assignment engine 408 are possible within the scope of the subject matter.

The illustrated advertisement assignment engine 408 includes an image analysis input 802, a database interface 804, an advertisement assigner 806, and an embedding selector 808. The advertisement assigner 806, in turn, includes a relevance matching engine 810, a user interest matching engine 812, and a budget evaluator 814. The relevance matching engine 810 may further include a content comparator 816, including a description comparator 818 and a visual feature comparator 820, an adjoining text comparator 822, an annotation comparator 824, and a relevancy scorer 826 that uses relevancy scores 828.

The image analysis input 802 receives, via the database interface 804, analyzed images 200 to match with advertisements 202. Each image 200 can be associated with one or more advertisements 202. The embedding selector 808 allows selection of advertisement embedding: an overlay engine 830 can place the advertisement 202 on the image 200 or the juxtaposition engine 832 can place the image 200 nearby the image 200. The advertisement assignment engine 408 can utilize one or more criteria for matching an advertisement 202 with an image 200.

The relevancy matching engine 810 has a content comparator 816 that can associate an advertisement 202 with an image 200 based on a content of the image 200. That is, the visual feature comparator 820 and the description comparator 818 use visual content and descriptions of the content of the image 200 in assigning relevancy between advertisement 202 and image 200. For example, in FIG. 2, the advertisement 202 relates to ski helmets and the image 200 has a skiing theme. In FIG. 3, the image 306 is about scenery, and the advertisements 302 and 304 relate to digital cameras and touring. The adjoining text comparator 822 and annotation comparator 824 use the text near an image 200 and annotation assigned by an image owner 106 as relevancy criteria. In one implementation, such nearby text and annotations are not considered content of the image 200 itself. Visual features and description, however, as derived by the content analyzer 406, are considered content of the image 200. The relevancy scorer 826 may weight these various criteria for matching an image 200 with an advertisement 202 and calculate whether the advertisement 202 and image 200 match beyond a threshold.

Text-based relevancy matching can be directly applied by the relevancy matching engine 810. Text information can include text surrounding an image 200 and textual description derived from the image comprehension engine 702 of the content analyzer 406. In one variation, the relevancy matching engine 810 separates the content-based textual information derived by the image comprehension engine 702 from the textual information surrounding the image 200 and measures these relevancies separately. The relevancy scorer 826 may combine these relevancy scores. Or, the relevancy matching engine 810 may take both types of textual information and also visual-audio features into consideration.

The user interest matching engine 812 uses an image owner's interests, if available, as a matching criterion. A user's interests may be discernible form the user's profile and/or surfing logs. Thereby, associated advertisements 202 can be more relevant to a particular viewer's interests.

The budget evaluator 814 can take into account a budget specified by an advertiser 110, when performing matching optimization. That is, advertisers 110 may pay for doing advertising through the image advertising service 102. The budget may determine an exposure period for a particular advertisement 202, which can influence the matching decision.

Exemplary Advertisement Delivery Engine

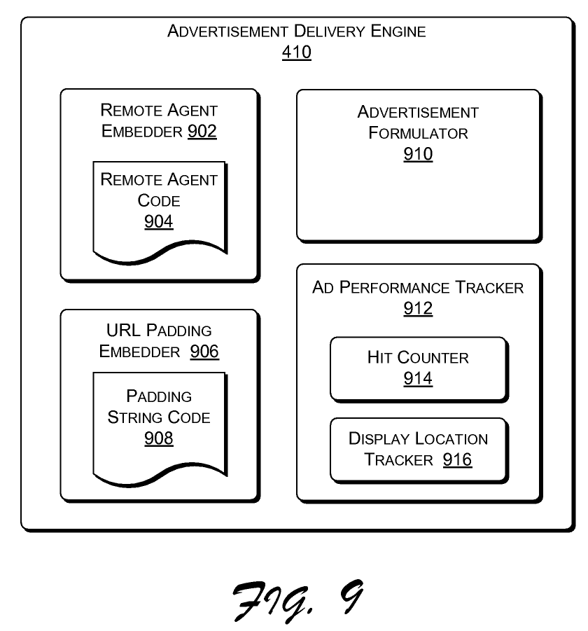

FIG. 9 shows the advertisement delivery engine 410 of FIG. 4, in greater detail. The advertisement delivery engine 410 delivers the assigned advertisements 202 to the corresponding images 200 in the corresponding website 108. The illustrated implementation is only one example configuration, for descriptive purposes. Many other arrangements of the components of an exemplary advertisement delivery engine 410 are possible within the scope of the subject matter.

The illustrated version of the advertisement delivery engine 410 includes a remote agent embedder 902 for sending remote agent code 904 to a website 108, a URL padding embedder 906 to send padding string 908 to a website 108, an advertisement formulator 910, and an advertisement performance tracker 912 including a hit counter 914 and a display location tracker 916.

In one implementation, when a user registers his website 108, the image advertising service 102 generates a piece of code—the remote agent 904—for the user to insert into the source code of the website 108. The remote agent code 904 automatically embeds the relevant advertisements 202 into corresponding images 200 in the website 108/webpage.

In another implementation, when an image owner 106 registers his website 108, the image advertising service 102 generates a URL padding string 908 for each image 200 in the website 108. The image owner 106 adds this padding string 908 to the URLs of the images 200 in the website 108. Then, the padding string 908 embeds the advertisements 202 into the corresponding image 200.

Beside advertisement embedding and rendering, the advertisement delivery engine 410 may also include the advertisement performance tracker 912 to track display statuses. For example, the hit counter 914 may count how many times an advertisement 202 is displayed and/or clicked, and the display location tracker 916 records a location or context of the advertisement's exposure.

The advertisement formulator 910 selects a form for rendering the advertisement 202. For example, advertisements can be cast as still text, a still image, animation, flying text, moving image, video, disappearing text, fading image, hyperlink, an icon, a sound, music, etc.

Exemplary Method

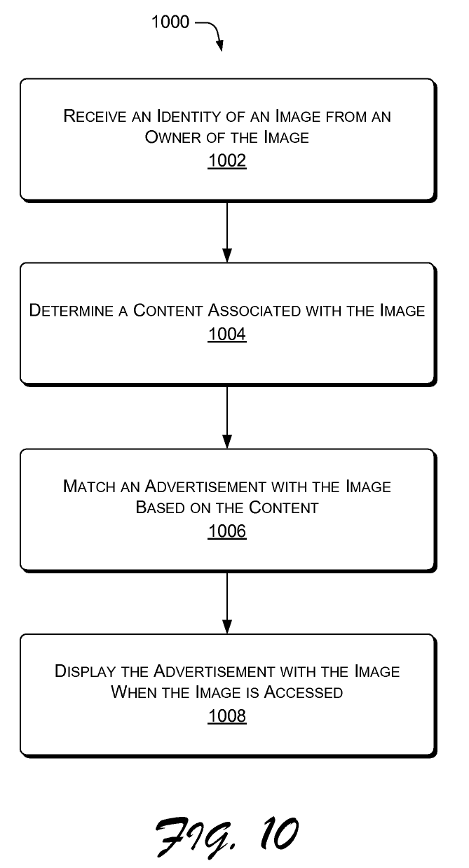

FIG. 10 shows an exemplary method 1000 of image advertising. In the flow diagram, the operations are summarized in individual blocks. The exemplary method 1000 may be performed by hardware, software, or combinations of hardware, software, firmware, etc., for example, by components of the exemplary image advertising service 102.

At block 1002, an identity of an image is received from an owner of the image. In one implementation, an image owner uploads images to be registered with an online image advertising service. In another implementation, the image owner registers a website containing images, such as a dynamic image collection. The image advertising service may crawl the registered website initially and periodically to discern images that exist on the website and to find context of the discovered images, such as surrounding text that provides clues to the visual features, content, and themes of discovered images.

At block 1004, a content associated with the image is determined. In one implementation, a content analyzer of the online image advertising service parses each submitted image to map visual features to a textual description and to detect visual objects in the images and try to recognize the detected objects. By automatic image comprehension, the image advertising service determines content and themes of each image, and may score the strength of each content or theme.

At block 1006, an advertisement is matched with the image based on determination of the associated content. Exemplary relevancy matching is applied to balance different criteria by which a given advertisement may be matched with an image. The various criteria may include comparisons of a candidate advertisement with: visual features of the image, visual objects recognized in the image, themes detected in or assigned to the image, annotation assigned to the image, descriptions of the image mapped from visual features of the image, text strings near the image on a website, different images found near the image on a website, a user interest associated with the image, a budget of an advertiser associated with the advertisement; the quality, cleverness, and artistic value of the image; the likely popularity of the image, etc.

At block 1008, the advertisement is displayed when the image is accessed. In one scenario, code is embedded at the image owner's website to perform the actual embedding of the advertisement with the image. The advertisement is placed in a non-salient part of the image where the advertisement will not distract or occlude, or the advertisement may be placed near the image. Alternatively, the advertisement may overlay the image, but appear and disappear within an interval. The advertisement may be of various forms, such as a still text, a still image, an animation, a flying text, a disappearing text, a fading image, a moving image, a video, a hyperlink, an icon, sounds, music, etc.

The image advertising method 1000 can be applied to email images, Instant Messaging (IM)-mediated images, images for mobile devices, and even conventional image-handling services such as traditional photo developing. In a SMS or MMS context for mobile devices, the image advertising method 1000 can insert advertisements into shared or sent images. In each of these different implementations, the image owner 106 may be compensated monetarily or by a reduction in charges/subscription rates for the services within which the image owner 106 is submitting images as a medium for the advertisements.

Conclusion

Although exemplary systems and methods have been described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A computer-executable method, comprising:
receiving an identity of an image from an image owner;
determining a content associated with the image;
matching an advertisement with the image based on the content; and
displaying the advertisement with the image when the image is accessed.

2. The computer-executable method as recited in claim 1, wherein receiving the identity of the image includes registering the image with an online service that performs the determining, the matching, and the displaying.

3. The computer-executable method as recited in claim 1, wherein receiving the identity of the image comprises registering a website, a device, an email service, an instant messenger account, or a printing service that contains or uses the image with a service that performs the determining, the matching, and the displaying.

4. The computer-executable method as recited in claim 1, wherein receiving the identity of the image includes one of: crawling a website or connecting to one of a device, email service, printing service, or messenger service registered by the image owner to find the image and to find text and images associated with the image.

5. The computer-executable method as recited in claim 1, wherein determining a content of the image includes automatically determining a theme of the image.

6. The computer-executable method as recited in claim 1, wherein determining a content of the image includes automatically mapping a visual content of the image to a textual description.

7. The computer-executable method as recited in claim 1, wherein determining a content of the image includes one of: detecting a visual object in the image or recognizing the visual object in the image.

8. The computer-executable method as recited in claim 1, wherein determining a content of the image includes determining a segmentation of the image for placing the advertisement in a non-salient region of the image.

9. The computer-executable method as recited in claim 8, wherein determining a segmentation of the image includes evaluating an image location for placing a hyperlink.

10. The computer-executable method as recited in claim 1, wherein matching an advertisement with the image includes determining a relevance of the advertisement to the image based on at least one of:
a visual feature of the image;
a visual object recognized in the image;
a theme detected in the image;
a theme assigned to the image;
an annotation assigned to the image;
a description of the image mapped from a visual feature of the image;
a text string near the image; or
a different image near the image.

11. The computer-executable method as recited in claim 1, wherein matching an advertisement with the image includes determining a relevance of the advertisement to the image based on a user interest associated with the image.

12. The computer-executable method as recited in claim 1, wherein matching an advertisement with the image includes determining a relevance of the advertisement to the image based on a budget of an advertiser associated with the advertisement.

13. The computer-executable method as recited in claim 1, wherein matching an advertisement with the image includes selecting whether to merge the advertisement with the image, whether to overlay the advertisement with the image, and whether to juxtapose the advertisement nearby the image.

14. The computer-executable method as recited in claim 1, wherein displaying the advertisement with the image includes displaying the advertisement as one of: a still text, a still image, an animation, a flying text, a disappearing text, a fading image, a moving image, a video, a hyperlink, an icon, or a sound.

15. The computer-executable method as recited in claim 1, wherein displaying the advertisement with the image includes embedding a remote agent in one of a website, device, email service, messenger service, or printing service hosting the image to embed the advertisement in the image.

16. The computer-executable method as recited in claim 1, further comprising paying the image owner for displaying the advertisement with the image when the image is accessed.

17. The computer-executable method as recited in claim 16, further comprising tracking a number of times the image is accessed to pay the image owner in relation to the number.

18. An online service, comprising:
a registration framework to register an image-bearing medium of an image owner with a service;
a content analyzer to determine a content associated with an image in the medium;
an advertisement assignment engine of the service to match an advertisement with the image based on the content; and
an advertisement delivery engine to display the advertisement with the image when the image is accessed.

19. The online service as recited in claim 18, wherein the advertisement assignment engine determines a relevance of the advertisement to the image based on at least one of:
a visual feature of the image;
a visual object recognized in the image;
a theme detected in the image;
a theme assigned to the image;
an annotation assigned to the image;
a description of the image mapped from a visual feature of the image;
a text string near the image;
a different image near the image;
a user interest associated with the image; and
a budget of an advertiser associated with the advertisement.

20. A computer system, comprising:
means for receiving a proprietary image;
means for associating an advertisement with the proprietary image; and
means for compensating an owner of the proprietary image for displaying the advertisement with the image.
